(19) United States
(12) Patent Application Publication
(10) Pub. No.: US 2006/0151463 A1
(43) Pub. Date: Jul. 13, 2006

(54) Electric cooker

(76) Inventor: Guang Jian, Guangdong (CN)

Correspondence Address: J C PATENTS, INC., 4 VENTURE, SUITE 250, IRVINE, CA, 92618, US

(21) Appl. No.: 10/541,102

(22) PCT Filed: Dec. 26, 2003
(86) PCT No.: PCT/CN03/01133

§ 371 Date: Jun. 28, 2005

(30) Foreign Application Priority Data
Dec. 31, 2002 (CN) 021602735
Jun. 14, 2003 (CN) 031488609

(51) Int. Cl. A47J 27/00

(52) U.S. Cl. 219/429

(57) ABSTRACT

An electric cooker includes an upper cover, an inner container, a heater, a heat insulator and a temperature control system. It is characterized in that the distance between the heater and the inner container is larger than zero, a radiant chamber is comprised of the inner container and the heat insulator, the heater is installed in the radiant chamber, and the detector of the temperature control system is in the upper cover.

### TECHNICAL FIELD

The present invention relates to an electric cooker, and more specifically relates to an electric cooker which is not heated through heat transfer but mainly through heat radiation, and which is provided with a top steam temperature sensing device.

### BACKGROUND ART

Heat transfer technology using electric heating plates is adopted for all the electric cookers used widely at present, wherein the whole surface of the metal electric heating plate contacts the bottom of the inner container to transfer heat, and the temperature control detector directly detects the temperature at the outer wall of the inner container. For electric cookers with inner containers made from materials having low thermal conductivity and expansion coefficient greatly different from that of the metal, such as ceramics, natural stone or glass, the above-mentioned technical solution has the following problems.

1. Parts of the inner container is overheated so that the heating thereof is not uniform, resulting in great temperature difference and inner stress, and as a result, the inner container is likely to be broken.

2. As surface deformation is different between the metal electric heating plate and the inner container material after heating, the heating transfer surfaces cannot contact each other sufficiently. As a result, heat transfer efficiency is low; the metal electric heating plate is overheated and likely to be deformed by melting. Moreover, the different extent of deformation between the heated surface and the heating surface may produce a force impairing the safety in use of the inner container.

3. The port reserved for the temperature sensor in the center of the metal electric heating plate causes a cool area in the center of the bottom of the inner container, therefore, the detected temperature does not indicate the temperature in the cooker precisely, making it difficult to control the cooking temperature so that the food in the cooker may be over or insufficiently cooked.

4. It is difficult to make the arc and thickness of the outer wall of the inner container made from ceramics, glass etc. as uniform as those of the metal electric heating plate, therefore, great difference of heat transfer efficiency exists even among products of the same type, and as a result, the temperature control parameter cannot be standardized. This is disadvantageous for industrial production.

At present, the main solution for this technical problem is to enlarge the heated area, to provide a metal casing around the inner container, such as the invention disclosed in Chinese Patent ZL94211811.1, or to spray purple clay to a metal inner container, such as the invention disclosed in Chinese Patent ZL98226728.2. However, they cannot substantially solve the contradiction between the surface contact necessary for heat transfer and the different extent of deformation of the heated and heating surfaces.

The Chinese Patent application 00132867.0 filed by the present inventor disclosed for the first time an electric cooker heated by heat radiation. However, as part of the heat conducting strip still contacts the inner container directly, the problem of non-uniform heating and inaccurate temperature control still exists.

### CONTENTS OF THE INVENTION

With a view to the above technical problem, the present invention provides an electric cooker heated by means of heat radiation assisted by hot air conducting, having a steam heat-conducting temperature sensing device at the center of the top for precise temperature control, which is capable of solving the contradiction between the sufficient contact of the inner container and the heating plate necessary for heat transfer and the different extent of deformation and expansion thereof after heating and the temperature control problem in the conventional heat-transfer type electric cooker with bottom temperature detection function.

The technical solution of the present invention is embodied by an electric cooker comprising an upper cover, an inner container, a heater, a heat insulator and a temperature control system, wherein the distance between the electric heating tube used as a heater and the inner container is larger than zero, i.e. the electric heating tube does not contact the inner container directly, but is supported by an inner heat-insulating casing; the electric heating tube is surrounded by the inner wall of the heat insulator (including an outer heat-insulating casing, an intermediate heat-insulating casing, an inner heat-insulating casing and heat-insulating fiber) and the outer wall of the inner container, forming a radiant chamber; the detector of the temperature control system is disposed within the upper cover for detecting the temperature of the steam in the cooker.

The upper cover comprises an outer cover, an inner cover and a fixed temperature-controlling metal heat-conducting plate. A temperature controller is installed on the fixed temperature-controlling metal heat-conducting plate between the outer cover and inner cover. A steam outlet port is provided at the center of the inner cover.

The shape of the bottom of the inner container fits that of the concave surface of the electric heating tube.

A silica-gel sealing-ring is provided along the upper periphery of the inner container.

A temperature sensor for over temperature protection is provided at the bottom of the inner container.

The heat insulator has a three-layer structure consisting of an outer heat-insulating casing, an intermediate heat-insulating casing, and an inner heat-insulating casing, with the upper end of the inner heat-insulating casing contacting the inner container, and heat-insulting fiber provided between the inner heat-insulating casing and intermediate heat-insulating casing.

A drain tube is provided in the bottom of the inner heat-insulating casing.

As compared with the exiting technology, the present technical solution has the following notable effects:

1. Heating is conducted mainly by heat radiation from the electric heating tube, assisted by hot air conduction. As the whole outer wall of the inner container serves as heated surface, the temperature in the radiant chamber is uniform so that the inner stress caused by non-uniform heating of the inner container is reduced.

2. As close contact between the surface of heater and the heated surface is not required by heat radiation and hot air conducting is not affected by the deformation of the outer wall of the inner container, the deformation of the inner container will not affect the heat conducting efficiency. No force will be produced between the heater and the heated surface.

3. By providing the temperature control system at the top, as temperature detection is no longer affected by the heat conducting rate of the inner container, the problem that the temperature in the cooker is not indicated accurately and timely is solved.

4. By providing the temperature control system at the top, as the outer wall of the inner container dose not have to contact the temperature detector and no cool area exists at the bottom of the inner container, the inner container can be heated more uniformly.

5. As heat conducting efficiency is not affected by the deformation of the inner container and the low-standard, non-uniform shape of the inner container wall made from ceramics, glass etc. by firing, it becomes easy to handle temperature control parameters and is advantageous for mass production.

### DESCRIPTION OF FIGURES

FIG. 1. is a longitudinal sectional view of the electric cooker.

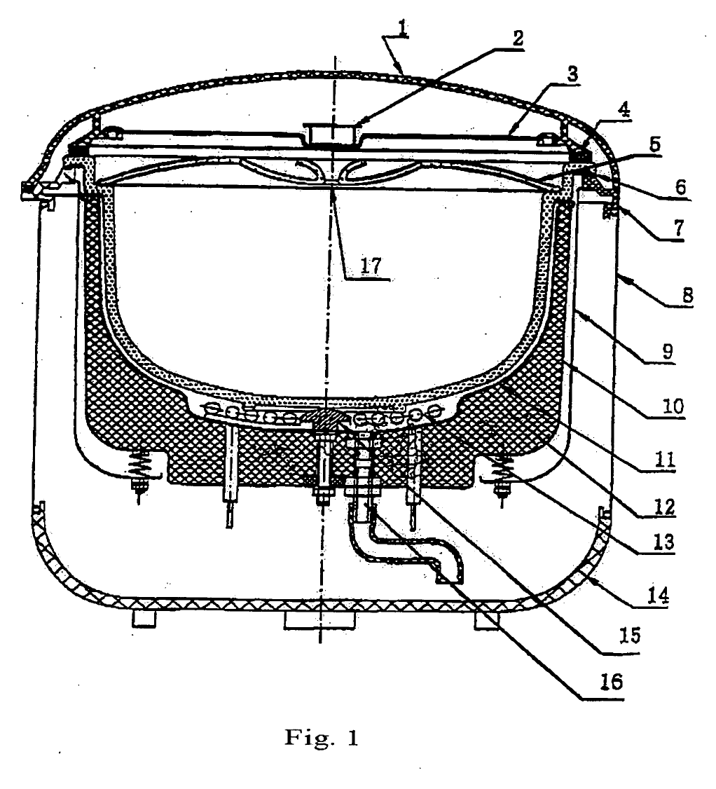

### MODE OF CARRYING OUT THE INVENTION

An electric cooker comprises an outer housing 8, an outer heat-insulting casing 9, an intermediate heat-insulting casing 10, an inner heat-insulting casing 11, heat-insulating fiber 12, an electric heating tube 13, a seat 14, a temperature sensor 15, a drain tube 16, an upper connecting ring 7, an inner container 6, an inner cover 5, a silica-gel sealing-ring 4, a fixed temperature-controlling metal heat-conducting plate 3, a temperature controller 2, a outer cover 1 and a steam outlet port 17. The fixed temperature-controlling metal heat-conducting plate 3 is provided between the outer cover 1 and the inner cover 3. The fixed temperature-controlling metal heat-conducting plate 3 is fixed on the outer cover 1 by means of screws. A concavity is formed in the center of the fixed temperature-controlling metal heat-conducting plate 3. The temperature controller 2 is riveted in the concavity. The temperature sensing surface of the temperature controller 2 tightly contacts the inner bottom face of the concavity. The silica-gel sealing-ring 4 is installed between the fixed temperature-controlling metal heat-conducting plate 3 and the outer cover 1, thus the above three parts are made into an integral one.

A radiant chamber is formed by the inner heat-insulting casing 11, and the outer walls of the electric heating tube 13 and inner container 6. Heat-insulating fiber 12 is provided between the intermediate heat-insulting casing 10 and outer heat-insulting casing 9, forming an excellent heat keeping chamber that makes the heat keeping effect more notable. The heating temperature of the electric heating tube 13 in this embodiment may reach 650° C., while the highest heating temperature of the cast aluminum plate of an conventional electric heating plate has to be controlled between 380° C. and 400° C. Otherwise the plate may be deformed or melted.

A steam outlet port 17 is provided in the center of the inner cover 5. The steam outlet port 17 is aligned with the concavity of the fixed temperature-controlling metal heat-conducting plate 3. The silica-gel sealing-ring 4 seals the upper peripheral of the inner container 6 so that hot steam jets through the steam outlet port 17 in the center of the inner cover 5 onto the concavity in the center of the fixed temperature-controlling metal heat-conducting plate 3. The concavity transfers the temperature of the steam to the temperature controller 2 which acts promptly after sensing the temperature of the steam. To ensure the safety of the user, a temperature sensor 15 is installed at the bottom of the inner container 6. Also, a drain tube 16 is provided at the bottom of the inner heat-insulting casing 11 to drain the water out of the seat in case the inner container is broken during use.

There exists no cool area in temperature sensing area at the bottom of the inner container in this embodiment. When the rice and water in the inner container are heated to boil, the bottom of the inner container reaches 100° C. When water is dried, the temperature of the whole bottom of the inner container is raised from 100° C. to 101.5° C. within 30-40 seconds (according to Chinese National Standard, the switch-tripping temperature is 100.5° C. to 104.5° C.). As at the bottom of a conventional electric cooker, there remains a cool area in the temperature sensing area. Take such an area having a diameter of 50 mm for example, after the temperature of the peripheral neighboring area around the cool area reaches 100° C., it takes 3-4 minutes more for the temperature of the temperature sensing area to be raised to the switch-tripping temperature 100.5° C. to 104.5° C. of Chinese National Standard. In the meanwhile, the temperature of the peripheral neighboring area has already reached above 108° C.

Thus, it can be seen that by means of conducting heat through radiation and detecting temperature at the top, the present invention has solved the technical problems of non-uniform heating and imprecise temperature control that exist in electric cookers having inner containers made from materials having low thermal conductivity, such as ceramics, natural stone or glass, and bottom temperature detection means, so that the present technical solution is suitable for industrial production.

1. An electric cooker comprising an upper cover, an inner container, a heater, a heat insulator and a temperature control system, characterized in that the distance between said heater and said inner container is larger than zero; a radiant chamber is formed by said inner cavity and said heat insulator; said heater is installed in said radiant chamber; a detector of said temperature control system is disposed within said upper cover.

2. The electric cooker of claim 1, characterized in that said upper cover comprises an outer cover, an inner cover and a fixed temperature-controlling metal heat-conducting plate; a temperature controller is installed on said fixed temperature-controlling metal heat-conducting plate between said outer cover and inner cover; and a steam outlet port is provided at the center of said inner cover.

3. The electric cooker of claim 1, characterized in that the shape of the bottom of said inner container fits that of the concave surface of electric heating tube.

4. The electric cooker of claim 1, characterized in that a silica-gel sealing-ring is provided along the upper periphery of said inner container.

5. The electric cooker of claim 1, characterized in that a temperature sensor for over temperature protection is provided at the bottom of said inner container.

6. The electric cooker of claim 1, characterized in that said heat insulator comprises three layers including an outer heat-insulating casing, an intermediate heat-insulating casing, and an inner heat-insulating casing, with the upper end of said inner heat-insulating casing contacting said inner container, and heat-insulting fiber provided between said inner heat-insulating casing and intermediate heat-insulating casing.

7. The electric cooker of claim 1, characterized in that a drain tube is provided at the bottom of said inner heat-insulating casing.

8. The electric cooker of claim 3, characterized in that a silica-gel sealing-ring is provided along the upper periphery of said inner container.

9. The electric cooker of claim 3, characterized in that a temperature sensor for over temperature protection is provided at the bottom of said inner container.

10. The electric cooker of claim 6, characterized in that a drain tube is provided at the bottom of said inner heat-insulating casing.
